(19) United States
(12) Patent Application Publication
(10) Pub. No.: US 2002/0072043 A1
(43) Pub. Date: Jun. 13, 2002

(54) Turning tables: chemical periodic chart puzzle and teaching device

(76) Inventor: William Possidento, Park Ridge, NJ (US)

Correspondence Address: John P. Halvonik, Suite 301, 806 West Diamond Ave., Gaithersburg, MD, 20878, US

(21) Appl. No.: 09/734,601

(22) Filed: Dec. 13, 2000

(51) Int. Cl. G09B 23/26

(52) U.S. Cl. 434/282

(57) ABSTRACT

A puzzle apparatus for the study of chemistry and its history and based upon the standard periodic table of the chemical elements. The puzzle includes a puzzle board for holding cubic shaped pieces corresponding to the elements of the periodic table. The puzzle board includes a depressed area capable of holding the cubic shaped pieces in a matrix array of elements that reflects the periodic table.

### FIELD AND BACKGROUND OF THE INVENTION

The invention relates to the field of teaching devices and, in particular, to a puzzle based upon the periodic table of the chemical elements and having a series of discrete cubes each corresponding to a chemical element as understood by the well known periodic table of the chemical elements. The base of the puzzle includes a puzzleboard that is shaped in the manner of the periodic table having those sections that hold an appropriate number of elements within the various rows and columns of the period chart that correspond to the properties and groupings of the elements according to theory.

Each of the cubes in the puzzle will depict one element of the periodic table and would include such chemical information as the electronic configurations (viz. how many electrons and in which electronic orbitals that are thought to exist), the chemical name, chemical symbol and/or atomic weight for that particular element and other properties thought to be relevant. The cubes should not contain the atomic numbers of any of the elements as that would otherwise make the puzzle too easy to solve. The cubes taken out of the puzzle board and are intended to be arranged back in the board according to the appropriate place in the periodic chart for each element in order to successfully complete the puzzle.

### PRIOR ART

While there are puzzles that are known in the prior art for teaching sciences, such as chemistry, there are no known puzzles that provide for the cubical representation of each of the elements of the periodic chart so that each such cube may be replaced upon a puzzle board that corresponds to the shape of the periodic table. Nor are there any known puzzles that are teach the construction of the periodic table on an element by element basis where the student only has a minimum of information pertaining to each element available to him in order to complete the puzzle.

### SUMMARY OF THE INVENTION

A learning puzzle for the study of chemistry and standard periodic table of the chemical elements. A puzzle board having a shape corresponding to that of the periodic table is provided and having a series of cubes that represents the elements of the periodic table for fitting into the puzzle board. The object of the puzzle is to replace these cubes representing the elements back into the puzzle board so that the finished puzzle will resemble the periodic table in the location of all the elements in their correct place in the table.

The puzzle board is necessarily shaped and sized to hold the appropriate number of elements in each of the rows and columns of the board. Preferably a depression in the appropriate shape may be formed in the puzzle board for holding the cubes corresponding to the appropriate elements. These rows and columns of course, correspond to the rows and columns of the periodic table with each of the various rows and columns having a meaning associated with the chemical theory of the elements.

The puzzle board will have at least seven rows in the array corresponding to the first seven rows of the periodic chart. Those rows corresponding to the Cesium and Thorium series of elements, a 2×14 array, may also be depicted by a separate depression that will hold the cubes corresponding to this array.

The challenge for the student then is to replace the elements of the periodic table as depicted by the cubes into their correct position on the periodic table. Each of the elements bears a distinct place in the periodic table that will be observed when the puzzle is completed. The student can and should use such information that is contained on each of the cubes in order to help him/her determine where each cube/element should go on the periodic table.

It is an object of the invention to provide a learning puzzle that is enjoyable to do and encourages students to recall and to understand the positions of the various elements as depicted in the well known Period Table of chemical elements.

Another object of the invention to provide a learning puzzle for allowing students to construct the periodic table of the elements by using a minimum of information about each element as depicted upon a cubic member associated with each such element.

Another object of the invention to provide a learning puzzle to provide students with a tabular representation of the elements of the periodic chart and allow them to fill up an empty version of this chart with cubic members corresponding to the various elements that make up the table.

Another object is to provide a challenging puzzle that can teach students the relationships of the various elements vis a vis one another with the periodic table of chemical elements.

Other advantages will be seen by those skilled in the art once the invention is shown and described.

### DESCRIPTION OF DRAWINGS

FIG. 1 standard period table showing the shape of the periodic table and placement of various elements according the atomic number of each element;

FIG. 2 detail of a cubic piece of the apparatus having information pertaining to atomic weight; electron orbital configuration; etc.

### DESCRIPTION OF THE PREFERRED EMBODIMENT

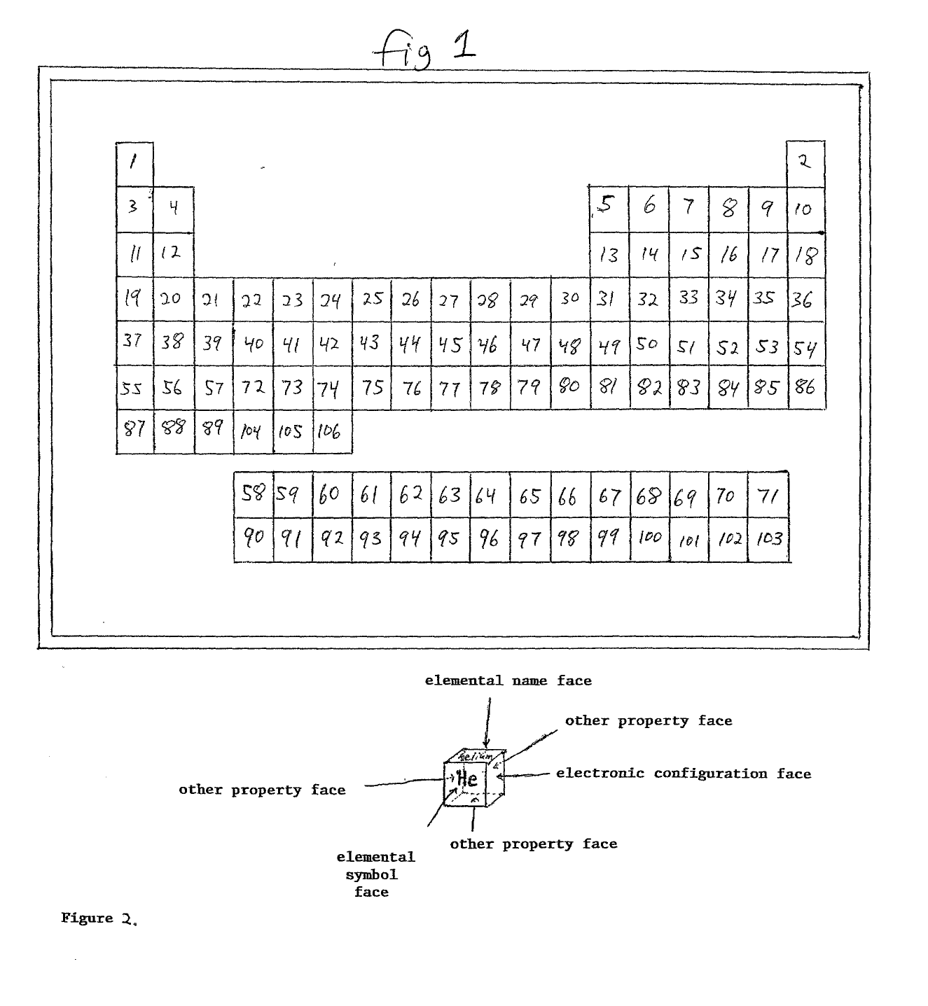

The overall shape of the periodic chart and the location of the elements is shown in FIG. 1. The nature and function of the periodic table was developed by Werner, among others as long ago as 1905 and is well known to those who have studied or taught the science of chemistry. The elements are arranged upon it in a numerical order otherwise known as the atomic number, a number corresponding to each of the elements in the table.

The shape of this periodic chart thus forms the basis for the puzzle board that will eventually hold all of the cubes in the proper order when the puzzle is completed. The cubes are intended to represent each of the elements that go into the periodic chart and contain information sufficient to allow the student to solve the puzzle (e.g. atomic name, symbol, etc.) without making the puzzle extremely easy (such as by including the atomic number).

The upper edge of the chart and hence, of the board, holds Hydrogen and Helium the numbers one and two elements in the table. They go in the upper left and upper right of the table/board and are sized and shape to hold the two cubes that correspond to these elements. In similar fashion, the second and third rows hold elements 3 through 18. A 2×2 array at the left edge and a 2×6 array at the right hand edge is the appropriate shape to hold these elements of the periodic table.

Moving further down the chart shows 3×18 array for those elements having atomic numbers 19 through 36; 37 through 54 and 55 through 86. Elements 87 and beyond fill out the bottom row of the periodic table as per the standard chart. The Cesium and Thorium series of elements may be represented by a separate depression that holds these elements in a 2×14 array; see FIG. 1.

The puzzle board should of course, be deep enough to hold each cube so that it does not fall out of the puzzle after it has been put in its place on the board. Each of the cubes might have on it, say as a minimum, the atomic name of that element and perhaps other information such as electron configuration information and/or the atomic weight of that element. The one bit of information it should not have on it is the atomic number of that element as otherwise this information would make the puzzle all too easy for the student to solve.

The information that is given on the cube can and should be used by the student to learn how to fit the cubes into the puzzle board. It is possible that the orientation of the cubes may be varied from exercise to exercise say for example with the names of each element being face up in one exercise and in another, with the atomic weight of each being on the upturned face. In this manner, the student can learn where the elements into the periodic chart based on any and all bits of information supplied e.g. the atomic weight the elemental name, the electronic configuration, etc.

Preferably each cube should include such information as the atomic symbol, the atomic weight, the electronic configuration (how many electrons and located in which orbital); atomic properties (such as how many bonding electrons it has to share) and informational terms such as “alkaline earth series;” etc. As each cube has six faces, each of the faces can hold a particular type of information such as atomic number on one side, atomic weight on another, etc. Other properties of each element can of course be included on each cube without varying from the spirit of the invention.

The challenge for the student is to use the information on the cubes, viz.: the name and atomic number of each element in order to correctly place the those elements (or rather, the tiles) into its correct place in the puzzle board (which of course represents the periodic table of elements). Advanced puzzles may include less information on the cubes in order to make the puzzle more challenging. While such cubes would not be the preferred version of the puzzle, nonetheless they may omit such information as atomic number, atomic weight, electron structure, etc. in order to make the puzzle more challenging to the advanced student. In such cases, the student may be given cubes with no more than the elemental name on them and attempt to finish the puzzle with that information alone.

The cubes themselves may be made of any state of the art material that can function as such and include plastics and other materials that can function within the nature of the invention. The puzzle board is merely polygon having a base and sides in the shape of the periodic chart. It should be sized to fit the appropriate number of cubes in the particular columns and rows that are appropriate including the elements of Hydrogen and Helium which are at the upper left and upper right corners, respectively of the periodic table. Wood, plastic and many other materials are likely capable of fulfilling this role.

I claim:

1. A two part teaching puzzle apparatus based upon the Periodic chart of chemical elements that places these elements in an array of rows and columns; where the location of each element in the array is based upon its chemical properties, the apparatus comprising: a first part puzzle board having a top edge, a bottom edge and two side edges, said edges having an outline shape reflective of said periodic chart, a second part comprising a plurality of cubic shaped piece having six faces, each of said pieces corresponding to a chemical element in the periodic table and having information on at least one of said faces of said cubic shape including information pertaining to the chemical name of a given said element, said puzzle board having shape for accommodating

2. The apparatus of claim 1 wherein said puzzle board comprises a main section having a left and right side edge and a top and bottom edge, said main section having a shape for accommodating a 3×18 array of said cubic shaped pieces, and a first upper section in connection with said top edge of said main section, said upper section having a left edge that is co-linear with said left side edge, said first upper section having a shape for accommodating a 2×2 array of said cubic shaped pieces, and a second upper section in connection with said top edge of said main section, said second upper section in connection with said top edge of said main section and having a right edge that is co-linear with said right edge of said main section, said second upper section having a shape for accommodating a 2×6 array of said cubic shaped pieces.

3. The apparatus of claim 2 wherein each of said cubes contains information pertaining to the chemical symbol of each of said chemical elements.

4. The apparatus of claim 3 wherein each of said cubes contains information pertaining to the electronic configuration of each of said chemical elements.
